(19) United States
(12) Patent Application Publication
(10) Pub. No.: US 2015/0165940 A1
(43) Pub. Date: Jun. 18, 2015

(54) ADJUSTMENT ELEMENT FOR A VEHICLE SEAT

(71) Applicant: Conti Temic Microelectronic GmbH, Nürnberg (DE)

(72) Inventors: Michael Schnell, Ingolstadt (DE); Gerhard Demmelmeier, Ingolstadt (DE); Carsten Sensche, Donauworth (DE)

(21) Appl. No.: 14/411,955

(22) PCT Filed: Jun. 28, 2013
(86) PCT No.: PCT/EP2013/063652

§ 371 Date: Dec. 30, 2014

(30) Foreign Application Priority Data
Jul. 2, 2012 (DE) 10 2012 211 392.4

(51) Int. Cl. B60N 2/44; B32B 37/00; F15B 15/10; B32B 37/18

(52) U.S. Cl. CPC B60N 2/4415; B32B 37/18; B32B 37/0076; F15B 15/103; B32B 2605/00

(57) ABSTRACT

An adjustment element for a vehicle seat. The adjustment element includes a bladder which can be filled with a pressure medium and which includes at least one first and one second film, which films are interconnected along a connection seam so as to form a bladder chamber. The adjustment element further includes a pressure medium line for letting the pressure medium into the bladder chamber, the pressure medium line being disposed at the connection seam between the at least one first and second films. The adjustment element also includes a pressure medium directing device for directing the pressure medium flow direction when the pressure medium flows into the bladder chamber, the pressure medium direction device being designed so as to direct the pressure medium flow away from the centre of the bladder chamber in order to minimize flow noises.

### CROSS REFERENCE TO RELATED APPLICATIONS

This application is the U.S. National Phase Application of PCT/EP2013/063652, filed Jun. 28, 2013, which claims priority to German Patent Application No. 10 2012 211 392.4, filed Jul. 2, 2012, the contents of such applications being incorporated by reference herein.

### FIELD OF THE INVENTION

The present invention relates to an adjustment element for a seat of a vehicle, in particular of a motor vehicle, and also to a vehicle seat having at least one adjustment element for altering a contour of a seat support surface. The invention further relates to methods for producing an aforementioned adjustment element.

### BACKGROUND OF THE INVENTION

In modern vehicle seats, bladders which can be filled with a pressure medium, in particular with compressed air, and which can be supplied with pressure medium via a respective pressure medium line, are located in a region of the seat surface or backrest (denoted jointly as the seat support surface). By filling a respective bladder with pressure medium, the volume thereof is increased, such that the properties of a backrest or seat surface can thus be altered in contour. For filling the bladders with pressure medium, the latter is initially generated by a pressure source, for example by a compressor, and conducted to a respective bladder via a corresponding valve, in particular an electro-pneumatic valve. If a pressure medium inlet channel is unfavorably arranged in the bladder, the flow of the pressure medium into the bladder can cause a clearly noticeable flow noise, which disturbs a person using the vehicle seat and which thus reduces the comfort during use of the vehicle seat.

### SUMMARY OF THE INVENTION

Thus, an aspect of the present invention is provides a possibility of allowing an adjustment component for a vehicle seat to be operated with minimized noise.

In this case, an adjustment element for a vehicle seat, in particular a motor vehicle seat, has the following features. Said adjustment element has a bladder which can be filled with a pressure medium and which consists of at least one first and one second film which are connected to each other along a connection seam, so as to form a bladder. The at least one first and one second film can be separate films or can be corresponding portions of a single film. Furthermore, the adjustment element has a pressure medium line for admitting the pressure medium into the bladder chamber, the pressure medium line being introduced at the connection seam between the at least one first and second film. Moreover, the adjustment element has a pressure medium directing device for directing the pressure medium flow direction when the pressure medium flows into the bladder chamber. The pressure medium directing device is designed in such a way that it directs the pressure medium flow away from the center of the bladder chamber or eccentrically. By this orientation of the pressure medium flow and/or pressure medium inflow into the bladder, the formation of turbulent flows during filling of the bladder chamber is avoided, and therefore the associated flow noise is also reduced, since, when the bladder chamber is being filled, the flow does not impinge directly on the wall of the bladder chamber lying opposite the pressure medium inlet (nor on an overflow opening possibly located at the center or middle for a further bladder). This reduction in the flow noise as the pressure medium flows into a bladder of the adjustment element greatly increases the ease of use of the adjustment element, which is frequently actuated in particular in the context of a massage program, thus resulting in greater user acceptance.

According to one embodiment of the adjustment element, the pressure medium directing device is designed such that it directs the pressure medium flow or pressure medium flow direction, during admission into the bladder chamber, along an inner wall of the bladder chamber. In this way, turbulent flows are also reduced and, consequently, flow noises are minimized.

According to a further embodiment of the adjustment element, the pressure medium directing device is formed by an end portion of the pressure medium line. This end portion of the pressure medium line can in particular also protrude into the bladder chamber. By combining these two elements of the pressure medium directing device and of the pressure medium line, the technical complexity of the adjustment element and therefore also the costs are minimized.

According to one embodiment of this described combination of the pressure medium directing device and of the pressure medium line, the pressure medium line has a straight end portion which is introduced into the connection seam in such a way that the pressure medium flow (from this straight end portion as pressure medium directing device) is directed away from the center of the bladder chamber. Thus, on the one hand, the technical complexity of combining two elements and the technical complexity of the overall adjustment element are minimized, since the pressure medium directing device according to the invention can be implemented only by means of specifically welding-in the pressure medium line.

According to a further embodiment of the abovementioned pressure medium line with the pressure medium directing device, it is also conceivable that the pressure medium line has an angled end portion which is arranged in the bladder chamber for deflecting the pressure medium flow (away from the center of the bladder chamber). Thus, once again, in addition to reducing the technical complexity by combining two elements, the method complexity is also minimized, since the pressure medium line can be introduced into the connection seam in almost any desired manner, and the pressure medium flow is deflected instead by the angled end portion. Moreover, according to a further embodiment, the adjustment element has a further bladder which can be filled with pressure medium and which is connected to the (first) bladder via an overflow channel which originates from a bladder portion of the (first) bladder, through which passes an axis extending perpendicular to a connection seam plane and through the center of the (first) bladder. Since the pressure medium flow direction is directed away from the center of the (first) bladder by the pressure medium directing device, the pressure medium flow does not impinge on the overflow channel directly, such that turbulent flows, and therefore also flow noises, are thereby reduced.

According to a further embodiment of the adjustment element, the connection seam is designed in particular as a weld seam. However, a connection seam in the form of an adhesively bonded seam is also conceivable. Advantageously, however, the weld seam is produced by means of high-frequency welding. In particular by means of welding, very stable and durable connections can be produced between the two films of the bladder.

According to a further embodiment of the adjustment element, the bladder can be filled by a gaseous pressure medium, in particular air. In this way, the bladder or bladder chamber can be filled in a simple and cost-effective manner. According to a further embodiment of the adjustment device, the connection seam has a circular shape. To put it another way, looking at the connection seam in a viewing direction perpendicular to the plane thereof reveals a circular shape of the connection seam. For adjustment devices, it is thus possible to produce bladders that can be filled easily and reliably and that can thus change shape.

According to a further embodiment of the adjustment device, the at least one first and second film has a noise-damping coating. The coating can be a foam coating by which flow noises occurring in the bladder can be further reduced. The coating, for example in the form of a foam coating, is in particular arranged in the bladder chamber.

According to a further embodiment, the at least one first and second films are made of plastic. In this way, a cost-effective adjustment element can be produced.

According to a further aspect of the invention, a vehicle seat, in particular a motor vehicle seat, with the following features is provided. The seat has a seat support surface (in the form of a seat surface and/or a backrest), wherein in the region of this seat support surface in the seat at least one adjustment element is provided according to an embodiment shown above and/or a variant thereof, which adjustment element is arranged in the vehicle seat in order to alter the contour of the seat support surface. In particular, such an alteration to the contour of the seat support surface can be used as a comfort function for a user in the context of a massage program. Especially in the context of a massage function in which the adjustment element is frequently actuated, the user comfort is increased, since an above-described bladder reduces the development of disturbing flow noises.

According to a further aspect of the invention, a method is provided for producing an adjustment element for a vehicle. In this case, at least one first and second film are first of all provided. A pressure medium line is then arranged between the at least one first and second film. Thereafter, the at least one first and second film are connected to each other at a weld seam in such a way that, between the two films, a bladder chamber is formed into which a pressure medium can be admitted via the pressure medium line. The pressure medium line has a straight end portion, which is introduced into the connection seam in such a way that the pressure medium flow is directed away from the center of the bladder chamber during admission of the pressure medium. An adjustment element for a vehicle seat is thus easily produced in which flow noises are reduced during admission of the pressure medium into the bladder or bladder chamber.

According to a further aspect of the invention, a method is provided for producing an adjustment element for a vehicle seat, in particular a motor vehicle seat, said method having the following steps. First of all, at least one first and one second film are again provided. A pressure medium line is then arranged between the at least one first and second film. Thereafter, the at least one first and one second film are connected to each other at a connection seam in such a way that, between the two films, a bladder chamber is formed into which a pressure medium can be admitted via the pressure medium line. The pressure medium line here comprises an angled end portion, which is introduced into the bladder chamber in such a way that the pressure medium flowing into the bladder chamber is deflected by it and thus the direction of flow is directed away from the center of the bladder chamber. In this way too, a simple method for producing the adjustment element is made available, by which disturbing noises caused by pressure medium flow during the operation of the adjustment element are minimized.

In this case, advantageous embodiments of the adjustment element, insofar as they are applicable to the vehicle seat and to the methods, are to be regarded as advantageous embodiments of the vehicle seat and the methods, and vice versa.

### BRIEF DESCRIPTION OF THE DRAWINGS

Illustrative embodiments of the present invention will now be explained in more detail below with reference to the accompanying drawings, in which:

FIG. 1 shows a schematic sectional view of a bladder according to a first embodiment of the invention;

FIG. 2 shows a plan view of the bladder in FIG. 1;

FIG. 3 shows a schematic plan view of a bladder according to a second embodiment of the invention;

FIG. 4 shows a sectional view of a multiple bladder as adjustment element according to a third embodiment of the invention;

FIG. 5 shows a schematic view of a vehicle seat with a plurality of adjustment elements, for example according to the embodiments set out above.

### DETAILED DESCRIPTION OF THE PREFERRED EMBODIMENTS

Reference is first made to FIG. 1, which shows a schematic cross-sectional view of an adjustment element SE for a vehicle seat, in particular a motor vehicle seat, according to a first embodiment of the invention. In this case, the adjustment element SE comprises a bladder BL which is here formed from two films F1 and F2. The films can be made in particular from plastic. As is shown on the left-hand side of the figure, the two films F1 and F2 are connected cohesively to each other at a connection seam VN. In this case, the connection seam can be configured, in particular, as a weld seam. By connecting the two films F1 and F2 (via the connection seam VN), a bladder interior or bladder chamber BLK is produced which can be filled with a pressure medium, in particular air. The pressure medium DM can be introduced into the bladder chamber via a pressure medium line DL. In this case, the pressure medium line DL is arranged between the two films F1 and F2 and is incorporated into the connection seam VN in such a way that a bladder chamber BLK sealed in respect of pressure medium is produced. It is also possible that the pressure medium DM can be let out of the bladder chamber BLK again via the pressure medium line DL.

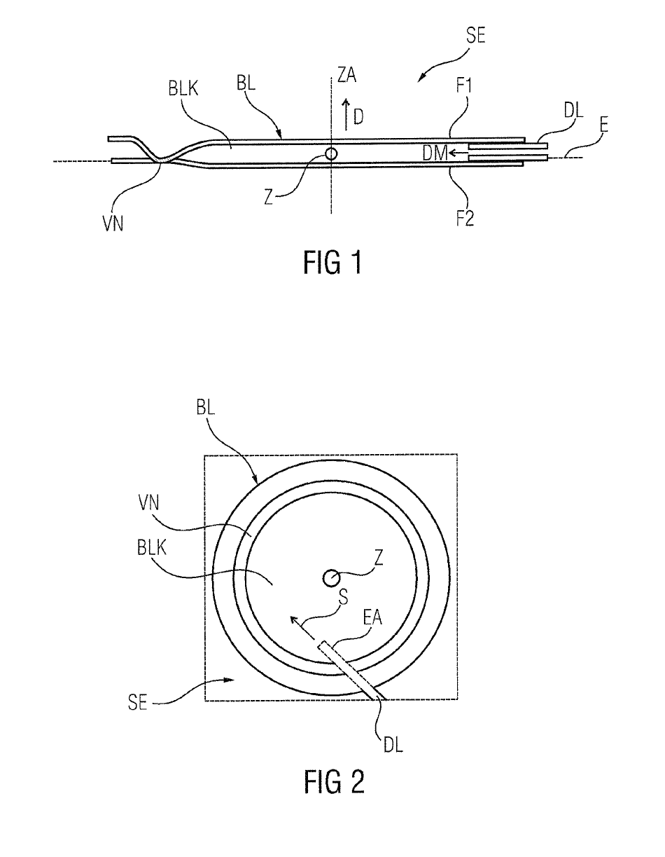

Assuming, for example, that the bladder BL is arranged with its second film F2 on a fixed support, the bladder BL will change shape when filled with pressure medium, and the film F1 will move in the direction of the arrow D, such that a pressure can be exerted by means of the adjustment element SE in the direction of the arrow D, upward in the figure. This specific provision of a pressure can be used in a vehicle seat in which an adjustment element is provided in the seat underneath a seat support surface, such that the contour of the seat support surface can be altered at the location of the adjustment element (as will be explained further below with reference to FIG. 5). As can better be seen by reference to FIG. 2, the center Z of the bladder is located in the middle of the bladder BL, wherein an axis ZA is provided through this center Z and perpendicular to the plane E of the bladder or the peripheral connection seam VN.

Reference is now made to FIG. 2, which shows a schematic plan view of the bladder shown in FIG. 1 according to the first embodiment, in a viewing direction along the axis ZA onto the plane E (cf. FIG. 1). Once again, the adjustment element SE is formed by the bladder BL, which can be filled with pressure medium by means of the pressure medium line DL. As can be seen from the figure, the connection seam VN connecting the two films F1 and F2 (cf. FIG. 1) has a circular shape, such that, in a plan view of the bladder BL, a bladder chamber BLK of circular circumference is produced. The center Z is located at the middle of this circle.

As can be seen from FIG. 2, the pressure medium line DL has a straight end portion EA which, in the view in FIG. 2, extends through the connection seam VN into the bladder chamber BLK. This end portion EA at the same time also constitutes a pressure medium flow directing device, by means of which pressure medium flowing through the pressure medium line DL into the bladder chamber BLK is directed along the arrow S. As can be seen from the figure, the pressure medium flow is directed along the arrow S away from the center Z, so as to avoid turbulent flows of the kind that occur in particular when the medium directly impinges the wall of the bladder chamber BLK lying opposite the pressure medium inlet. In particular, a direction of the pressure medium flow along an inner wall of the bladder chamber, especially tangentially in the embodiment in FIG. 2, is advantageous. In this embodiment of the adjustment element SE shown in FIG. 2, it should be emphasized that, by providing a straight end portion EA of the pressure medium line DL and by deliberate incorporation, in particular welding-in, of this end portion such that the pressure medium flow is oriented away from the center Z, it is possible for a bladder and/or an adjustment element SE to be produced in a simple manner and with minimal outlay in terms of process and device technology, in which the flow noise is greatly reduced when pressure medium is flowing in.

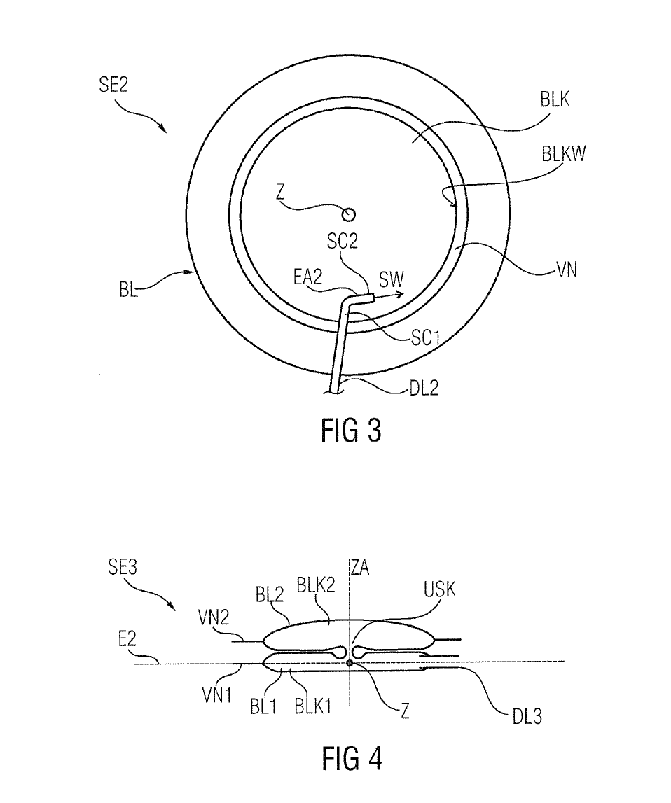

Reference is now made to FIG. 3, which shows a schematic plan view of an adjustment element SE2 for a vehicle seat, in particular a motor vehicle seat, according to a second embodiment of the invention. Here, the bladder structure corresponds to the bladder structure of the bladder of the adjustment element SE as shown in FIG. 1. In particular, a bladder BL according to FIG. 3 again comprises two films (not shown), which are connected to each other via a connection seam VN so as to form a bladder chamber BLK that can be filled with a pressure medium, in particular air. Compared to the first embodiment, the pressure medium line is formed differently in this second embodiment of an adjustment element SE2 shown in FIG. 3. As can be seen from FIG. 3, the compressed air line DL2 has an angled end portion EA2, wherein a first portion SC1 is routed through the connection seam VN, and a second portion SC2 at an angle to the first portion SC1 is provided for directing the pressure medium flow direction in the bladder chamber BLK. In particular, according to FIG. 3, the pressure medium flow is directed along the arrow SW, such that a flow is produced in a direction along an inner wall BLKW of the bladder chamber BLK. As a result, the pressure medium flow direction or pressure medium inflow direction is again directed away from the center Z of the bladder. This therefore once again also reduces the creation of turbulent flow and, consequently, the formation of disturbing flow noises.

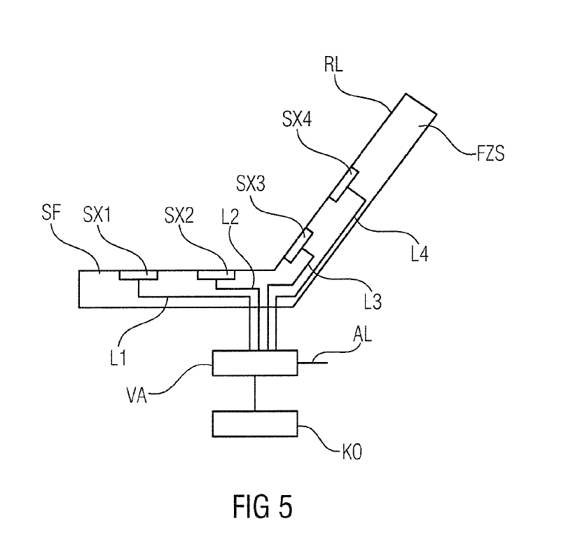

Reference is now made to FIG. 4, which shows a schematic cross-sectional view of an adjustment element SE3 according to a third embodiment. The characterizing feature of this third embodiment is that the adjustment element here has a multiple bladder (instead of a single bladder as in the previous embodiments). As can be seen from FIG. 4, the adjustment element SE3 comprises a first bladder or lower bladder BL1 which, as in the above embodiments, consists of two films which are connected to each other via a first connection seam VN1 (in particular a weld seam) so as to form a first bladder chamber BLK1 which can be filled with a pressure medium. Moreover, the adjustment element SE3 has a second or upper bladder BL2, also once again consisting of two films (or film layers) which are also connected to each other via a second connection seam VN2 (in particular a weld seam) so as to form a second bladder chamber BLK2 which can also be filled with a pressure medium. The two bladders BL1 and BL2 are connected to each other via an overflow channel USK. This overflow channel extends along an axis ZA which, in particular, passes through the center Z of the first bladder BL1. In particular, it is assumed here that the two bladders BL1 and BL2, or their bladder chambers, have a circular periphery, since the respective connection seams VN1 and VN2 also have a circular shape, as can be correspondingly seen, for example, in the single bladders according to FIGS. 2 and 3. Moreover, the axis ZA also extends perpendicularly with respect to a plane E2 of the bladder BL1 or corresponding to the plane of the peripheral connection seam VN1.

As in the single bladders described above, a pressure medium line DL3 is also provided, which is incorporated into the connection seam VN1 of the first bladder BL1, so as to produce either a pressure medium line that is straight but directed away from the center (cf. FIG. 2) or an angled pressure medium line for deflecting the pressure medium flow direction away from the center (cf. FIG. 3). In each case, the inflowing pressure medium (in particular compressed air) is deflected away from the center Z of the first bladder BL1, such that the pressure medium, on the one hand, does not directly impinge the opposite wall of the bladder chamber and, on the other hand, also does not impinge the overflow channel USK, which extends along the axis ZA extending through the center Z. The first bladder BL1 is first of all filled by the pressure medium flowing in through the pressure medium line DL3, wherein the pressure medium then flows further into the second bladder BL2, in order also to fill the latter. The shape of these two bladders thus changes, such that the two bladders each expand upward along the axis ZA in the figure and can thereby build up a pressure in this direction. By the deflection of the inflow direction of the pressure medium away from the center, an adjustment element SE3 can also be created here in which the formation of turbulent flows and, consequently, the occurrence of disturbing flow noises is reduced. Although only a double bladder is shown as adjustment element in FIG. 4, it is also conceivable to form triple bladders or multiple bladders with a similar structure.

Reference is now made to FIG. 5, which shows a schematic view of a vehicle seat FZS equipped with corresponding adjustment elements. As can be seen in FIG. 5, the vehicle seat (in particular a motor vehicle seat) FZS comprises a seat surface SF on which a user can sit, and a backrest RL against which the user can rest. The seat surface SF and the backrest RL are denoted jointly as a seat support surface.

In the specific example of FIG. 5, the seat surface SF comprises two adjustment elements SX1 and SX2, and the backrest RL comprises two adjustment elements SX3 and SX4, for adjusting a contour of the respective surfaces, either for forming a corresponding supporting function (e.g. lumbar support) or for altering the contour of the respective support surfaces within the context of a massage program. The adjustment elements SX1-SX4 can be formed in accordance with the adjustment elements described above in FIGS. 1-4. The adjustment elements in this specific case are pneumatic adjustment elements which can be filled by means of compressed air as pressure medium and are thus able to change shape in order to exert their adjusting function, i.e. to exert a pressure perpendicularly with respect to the respective support surface, upward in the image plane in the case of the adjustment elements SX1 and SX2, and obliquely and upward to the left in the case of the adjustment elements SX3 and SX4. In this case, compressed air is generated by a compressor KO and is routed via a valve arrangement VA with a multiplicity of valves via compressed air lines L1 to L4 selectively into the adjustment elements SX1, SX2, SX3 and/or SX4, in order to actuate the adjustment elements in a specific manner. The compressed air (as pressure medium) admitted into the adjustment elements can then also be let out again via the compressed air lines L1 to L4, the valve arrangement VA and, at that point, via a compressed air outlet channel AL.

Using the above-described adjustment elements according to the invention (for example as shown in FIGS. 1 to 4), a vehicle seat FZS can thus be produced in which disturbing noises caused by pressure medium flow noises are minimized.

1. An adjustment element for a vehicle seat comprising:
a bladder which can be filled with a pressure medium and which comprises at least one first film and one second film, which films are connected to each other along a connection seam so as to form a bladder chamber;
a pressure medium line for admitting the pressure medium into the bladder chamber, the pressure medium line being introduced at the connection seam between the at least one first and second films;
a pressure medium directing device for directing flow of the pressure medium when the pressure medium flows into the bladder chamber;
the pressure medium direction device being designed so as to direct the pressure medium flow away from the center of the bladder.

2. The adjustment element as claimed in claim 1, in which the pressure medium directing device is designed so as to direct the pressure medium flow along an inner wall of the bladder chamber.

3. The adjustment element as claimed in claim 1, in which the pressure medium directing device is formed by an end portion of the pressure medium line.

4. The adjustment element as claimed in claim 3, in which the pressure medium line has a straight end portion, which is introduced into the connection seam in such a way that the pressure medium flow is directed away from a center of the bladder chamber.

5. The adjustment element as claimed in claim 3, in which the pressure medium line has an angled end portion, which is arranged in the bladder chamber in order to deflect the pressure medium flow.

6. The adjustment element as claimed in claim 1, additionally having a further bladder which can be filled with the pressure medium and which is connected to the bladder via an overflow channel which originates from a bladder portion through which passes an axis extending perpendicular to a connection plane and through the center.

7. The adjustment element as claimed in claim 1, in which the connection seam is a weld seam.

8. The adjustment element as claimed in claim 1, in which the bladder can be filled with a gaseous pressure medium.

9. The adjustment element as claimed in claim 1, in which the connection seam has a circular shape.

10. The adjustment element as claimed in claim 1, in which the at least one first and second films have a noise-damping coating.

11. A vehicle seat comprising:
a seat support surface for a user;
at least one adjustment element as claimed in claim 1, which is arranged in the vehicle seat in order to alter the contour of the seat support surface.

12. A method for producing an adjustment element for a vehicle seat, comprising:
providing at least one first film and one second film;
arranging a pressure medium line between the at least one first and second film; and
connecting the at least one first film and one second film to each other at a connection seam in such a way that, between the films, a bladder chamber is formed into which a pressure medium can be admitted via the pressure medium line;
wherein the pressure medium line has a straight portion, which is introduced into the connection seam in such a way that the pressure medium flow is directed away from a center of the bladder chamber.

13. A method for producing an adjustment element for a vehicle seat, comprising:
providing at least one first film and one second film;
arranging a pressure medium line between the at least one first and second film; and
connecting the at least one first film and second film to each other at a connection seam in such a way that, between the films, a bladder chamber is formed into which a pressure medium can be admitted via the pressure medium line;
wherein the pressure medium line has an angled end portion, which is arranged in the bladder chamber so as to direct the pressure medium flow away from a center of the bladder chamber.

14. The adjustment element as claimed in claim 1, in which the bladder can be filled with air.
